(19) United States
(12) Patent Application Publication
(10) Pub. No.: US 2023/0419181 A1
(43) Pub. Date: Dec. 28, 2023

(54) MACHINE LEARNING USING STRUCTURALLY DYNAMIC CELLULAR AUTOMATA

(71) Applicant: Mahendrajeet SINGH, Boston, MA (US)

(72) Inventor: Mahendrajeet SINGH, Boston, MA (US)

(21) Appl. No.: 18/306,820

(22) Filed: Apr. 25, 2023

Related U.S. Application Data
(60) Provisional application No. 63/334,807, filed on Apr. 26, 2022.

(51) Int. Cl. G06N 20/00

(52) U.S. Cl. CPC G06N 20/00

(57) ABSTRACT

A plurality of environmental inputs is obtained and combined with a model and an attenuation factor to produce a plurality of intermediate outputs. The intermediate outputs are combined with the model and the attenuation factor to produce a plurality of final outputs.

### BACKGROUND

At the forefront of research and development in the engineering and computational fields, advances in artificial intelligence and machine-learning have been increasing the capacity of software algorithms for processing, evaluation, and decision-making capacity in a wide range of application areas such as data analysis, classification, decision support, robotics, genetics, and others.

Current algorithms used today for real-world applications, however, require enormous computational, data storage, and related energy requirements of these techniques. Moreover, the large amount of required training data and real-time computational requirements become challenging in real-world scenarios which may be dynamic or where the overall environment is not fully specified or known.

### SUMMARY OF THE DISCLOSURE

The described technology provides a “biologically plausible” model of an organism's brain used to potentially generate the types of highly complex phenomena observed in cognitive processes such as learning, memory, and abstraction. The models described here perform the required “computations” with limited energetic resources, quickly and efficiently.

The specific sub-fields of Artificial General Intelligence and Reinforcement Learning focus on the capacity of an agent to navigate a previously unknown environment, respond to sensory cues, make decisions and take actions and most importantly, to “learn” to respond to positive cues (“rewards”), and to avoid negative consequences (“penalties”). Reinforcement learning techniques, often in combination with neural-network and various deep-learning methods, have recently been very successful in certain types of contexts such as game-playing at human or even super-human levels.

However, the techniques available for neural-network and deep learning types of methods require significant brute-force approaches to feeding large amounts of data, computing n-dimensional arrays, running training sequences and so on. Effective and common techniques in this realm, including gradient descent, support vector machines, and backpropagation, are all computation-heavy and memory-intensive. In reinforcement learning, the resources needed to calculate and iterate the value function and policy updates in many training episodes and sessions are also extremely large, to the point of being impractical in many real-world use-cases.

The approach described here is an algorithmic method for machine learning and behavior functions that allow an autonomous agent to navigate an environment, respond to sensory cues, make decisions and take actions in response to positive signals (“rewards”) and negative ones (“penalties”), and make near-optimal choices in a consistent and effective way without incurring the heavy computing costs of traditional techniques. The computational technique described is novel type of structurally dynamic cellular automaton.

Cellular automata form a class of computational structures that are inherently parallel and also capable of expressing any type of (universal) computation. Although in most previous methods/implementations, cell values are discrete and/or binary, and the underlying graph (or lattice) structures are regular and fixed, this particular method uses dynamically changing graph structures and edge weights, as well as continuously valued cell states, though still maintaining discrete time values.

The specific problem being addressed by this method for machine learning is one of learning from rewards and penalties in the environment, and subsequently adjusting the behavior of an autonomous agent to seek those rewards and avoid penalties as desired by the operator. The underlying problem is one of establishing the correct “distance” or value metric in order to prioritize certain states over others, and a computational mechanism to evaluate that metric in a dynamic environment.

The method takes sensor inputs of the environment that are measured to be simultaneous or coincident and transforms that “time-like” information into “space-like” information in the form of a weighted undirected graph, called the Coincident Matrix which acts as the dynamic repository of system “memory”. This transformation is expressed in the matrix update function [psi] and generates an updated representation in a highly compressed and lightweight form.

As new inputs are sensed and the matrix is updated, a single, identical cell value update function [phi] then operates on the individual cell values, over a selected number of recursions, to generate a new value state for every node in the system. This final state is the computational result that is used to select/trigger specific action, or in the more general case, express the compositional value of the whole matrix.

By pre-establishing reward node and connection values in the matrix, the combination of the “topology” of the matrix (its “memory”, so to speak) and the external sensor stimuli as input results in an energy gradient that is expressed in the computed node values described above. This gradient is then used to select/disambiguate between possible next actions.

As an algorithm of an adaptive complex system, there are characteristics in the matrix update functions that are configured to generate explorative behavior in the agent in the case where the energy gradient is equal in all directions. This is accomplished by modulating the “distance” metric of the node edges, which can also be thought of as impedance or resistance value.

The method is able to handle additional environment data as well as new reward/penalty settings, without having to modify the prior data, or suffer from the “catastrophic forgetting” problem often experienced in comparable RL/machine learning systems. Additionally, the method is inherently “context-sensitive” in terms of reward selection behavior. This is particularly useful in “continual learning” applications for autonomous computers, robots, and autonomous agents in general which may be operating in previously unmapped/unknown environments.

There are a number of beneficial characteristics inherent in the use of the described technology as a mechanism for optimal choice selection in machine learning environments:
1. Low computational requirements: The iterations required are very simple and do not require multiple passes through the choice graph, value-function calculations, prediction or optimization, probability distribution handling, etc. The computation is highly mechanistic and may be implemented as a physical circuit (for example, as an application-specific integrated circuit, a field-programmable gate array, or discrete logic elements), which may be very useful in real-time environment applications (robotics, for instance).
2. Low memory requirements: Almost all of the input data and the output data are not retained. They are simply thrown away, keeping only the very compact model itself, and the “stub” of latency from the last output. In other words, the entire “experience” of the agent as it traverses the choice graph is encapsulated in these two registers.
3. Efficient Updating in Dynamic Environments: Because the input-to-output process always passes through the model, which itself may be updated “on-the-fly’: only the new outputs required by the instantaneous new input list are generated when they are needed, without having to calculate any regions of the graph that are not “active” or affected by the localized action of the agent. In other words, any new information updated about the graph is available in the model, but only calculations having to do with the next “step” of the agent need to be computed.
4. Highly Generalizable: The way in which the model is structured means that the same input/output and connectivity descriptions can be used for sensor, action, or reward types of circuits.
5. Experience Aggregation (“Hive Mind”): The manner in which the model is updated, including the reinforcement factor calculation, makes it easy to “merge” the “experiences” of multiple agents traversing a common graph, without having to worry if there's is any, partial, or no overlap in “experience”. The compactness of the model also makes real-time updating/aggregation from multiple agents more efficient if required by the application.

There are numerous potential real-world applications for the described technology. These may include, among others:
1. Autonomous Control Systems: A feature of the described technology is the ability to navigate environments and generate reward/penalty gradients in order to make decisions. For a range of applications such as industrial robots and drones, as well as in virtual environments such as video games, autonomous agents operating in a dynamic environment may require constant adjustments to the reward function in order to operate effectively. One of the problems in existing machine-learning models is the problem of “catastrophic forgetting”, where new environmental information and changing reward programming is difficult. The described method does not exhibit these constraints.
2. Multi-agent coordination and data-sharing for robot/drone swarms. The matrix representation inherent in the method provides a highly compressed representation of the environmental “knowledge” acquired by the autonomous agents which can be shared amongst a group of robots or drones that share a common sensor set. This allows for near-continuous updating of the reward gradient relationship between separate agents, so that “nearness” metrics learned by one agent can be immediately used by all the others. By separating the reward programming between agents, teams of agents can share the environmental representation but be driven by different rewards as required (team specialization).
3. Compositional data for semantic/language representations. In language-oriented applications, one of the problems is how to represent “composite” values for different labels/values/concepts, especially as new information and associations to labels are added. The method's dynamic allocation of new connections to labels (sensors) allows for seamless updating of new semantic relationships, and the generation of new, context-sensitive composite states that are simply the state of the cellular automata after processing.
4. Data Analysis: In particular classes of time-series data (multiple, linked time-series), the method allows for analysis of coincident events in different data-streams that does not use the time-variation of the series themselves but uses the coincidence metric to analyze the relationships between the time series. In other words, instead of looking at the time variation of a series, the method looks at the coincident events across multiple series. These time-series may be of medical/biological data, industrial data, meteorology, financial, or other.

In one aspect, the described technology relates to a method in which a plurality of environmental inputs is obtained and combined with a model and an attenuation factor to produce a plurality of intermediate outputs. The intermediate outputs are combined with the model and the attenuation factor to produce a plurality of final outputs. In some embodiments, the plurality of environmental inputs is obtained from an output of a model and, in other embodiments, the inputs are obtained from a sensing device. In other embodiments, the obtained plurality of environmental inputs is combined with a model matrix and a matrix of attenuation factors to produce a plurality of intermediate outputs and, in some of these embodiments, the obtained plurality of environmental inputs is combined with a model matrix, a matrix of attenuation factors and the identity matrix to produce a plurality of intermediate outputs. In some other embodiments, the intermediate inputs are combined with the model and the attenuation factor a predetermined number of times to produce a plurality of final outputs. In certain specific embodiments, the model is updated based on the obtained inputs and, in some of the certain embodiments, a de-inforcement factor is applied to the model.

In another aspect, the described technology relates to a Machine Learning system having an input register storing a plurality of obtained environmental inputs, a model storing associations between ones of the plurality of obtained environmental inputs, an attenuator combining attenuation values with the model to produce an attenuated model, and a combiner producing a plurality of output values based the attenuated model and the plurality of obtained inputs. In some embodiments, the system includes a plurality of sensors obtaining environmental inputs. In other embodiments, the model and attenuation values are matrices and the combiner a plurality of output values based on the plurality of environmental inputs, the model matrix, the matrix of attenuation factors and the identity matrix. In certain embodiments, the system includes a model maintainer updating the model based on the obtained inputs and, in some of these embodiments, the model maintainer applies a de-inforcement factor to the model.

### BRIEF DESCRIPTION OF THE DRAWINGS

The foregoing and other objects, aspects, features, and advantages of the described technology will become more apparent and better understood by referring to the following description taken in conjunction with the accompanying drawings, in which:

FIG. 1 depicts a diagrammatic view of one embodiment of the described machine learning system;

FIG. 2A depicts an embodiment of code implementing the described update function Φ and the described matrix update function ψ;

FIG. 2B depicts an embodiment of code implementing the described recursion and attenuation functions;

FIGS. 3A-3C depict various paths taken by an agent in an eight-by-eight grid with penalties of varying amounts included in the grid;

FIG. 4A depicts a path taken by an agent in a ten-by-ten grid with no penalties included in the grid;

FIG. 4B depicts a path taken by an agent in a ten-by-ten grid with a penalty barrier included in the grid;

FIGS. 5A-5P depict heat maps showing signal gradients at each step of an agent's traversal of an eight-by-eight grid with no penalties;

FIGS. 6A-6H depict signal gradients and graph plasticities for selected steps of an agent's traversal of an eight-by-eight grid with no penalties;

FIG. 7A depicts the results of a random trial using a 64-node lattice graph and 100 random start/end points, showing success rate within 64 steps and a histogram of path lengths;

FIG. 7B depicts the results of a random trial using a 64-node ordered Watts-Strogatz graph and 100 random start/end points, showing success rate within 64 steps and a histogram of path lengths;

FIG. 7C depicts the results of a random trial using a 64-node 50% randomized Watts-Strogatz graph and 100 random start/end points, showing success rates with 64 steps and a histogram of path lengths; and

FIG. 7D depicts the results of a random trial using a 64-node fully randomized Watts-Strogatz graph and 100 random start/end points, showing success rate within 64 steps and a histogram of path lengths.

In the drawings, like reference characters identify corresponding elements throughout and like reference numerals generally indicate identical, functionally similar, or structurally similar elements. Although specific features of various embodiments may be shown in some drawings and not in others, this is for convenience only. Any feature of any drawing may be referenced and/or claimed in combination with any feature of any other drawing.

### DETAILED DESCRIPTION

As described here, the developed algorithm avoids the use of computationally expensive techniques currently used in the art. The design selected uses coincident stimuli as the fundamental building block of the model. As used in this document, “coincident” means the sensing of stimuli that happen at substantially the same time. The developed algorithm can react to a set of stimuli and generate outputs that bear a resemblance to simple cognitive phenomena, including concepts such as learning, memory, and abstraction. A target behavior of the model is to generate optimal choices in a choice “landscape,” which can be expressed in a “choice graph,” analogous to a knowledge graph.

A minimal set of information about coincident inputs or stimuli, used iteratively on each input cycle, can generate an output set that can bias the system towards one edge or another in the choice graph, once a reward/penalty function is also built into the model, for example, as an intrinsic characteristic connected to certain types of input/stimuli.

Thus, if the choice graph represents a physical space or network (though it may not), the model contains an evolving understanding of the connections between nodes/vertices in the graph. By firing input signals along those connections, attenuating at each “jump,” a shorter route will exhibit a stronger signal than a longer one, as it will experience less attenuation. Given a distal node with a strong reward signal, the model biases or infers towards the stronger signal and therefore chooses towards the shortest path to the reward. In some aspects, this may be interpreted as the model self-generating a signal gradient as it traverses the choice graph, which, in turn, determines the subsequent choice of the model.

Because the model is concerned with coincident data, time-series information need not be kept, as is necessary for most reinforcement learning techniques, which must assess the overall value of every path explored in order to optimize for the best path. In the described model the coincident connections are represented in the choice graph, with weightings. This also obviates the need for deep learning techniques used to do estimation of the value function, which is also quite computation heavy.

Additionally, in order to be relevant to real-life applications and phenomena observation, the model/method, should also be scalable/extendable: i.e., it should act as an “atomic” model of cognition, wherein the constructs of the model can be built upon and extended (with more experience/data, more capacity/resources) to be able to explain and predict more complex cognitive phenomena/behaviors.

The basic functions/characteristics of the method are as follows:
The “environment” is specified as an “undiscovered” choice graph, defined in a two-dimensional adjacency matrix or array.
As the agent traverses the graph, the “discovered” edges of the graph are used as inputs, and any edges available to a node are treated as coincident. These coincident relationships are stored in the “core”, which may be a two-dimensional array that forms the main “experience template” of the system.
The inputs may be fed multiple times through the coincident matrix, generating “second” and “third-hand” outputs, etc. based on the configuration, described herein as a waterfall of secondary, tertiary, etc. inputs/outputs that are iterated through the model.
The waterfall described above may have certain configurable attenuation characteristics, which means that the secondary, tertiary, etc. signals are progressively less strong than the original input. The number of waterfall “layers” may also be configurable.
The resulting sum of inputs constitutes the output or experience manifold and constitutes the state of the current experience, and/or the basis for any choice of future action.
The system updates the model based on the latest input set.
The system retains a “decayed” or “latent’ amount of the output that is summed to the next input/output cycle.

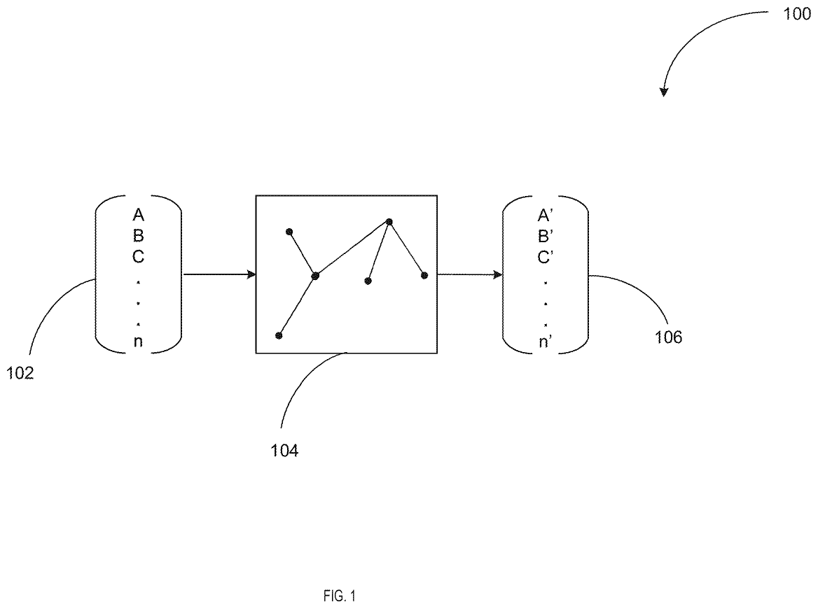

Referring now to FIG. 1, the general operation of one embodiment of the developed algorithm is depicted in the context of a single cell. As shown in FIG. 1, the model 100 takes sensory inputs 102 from the environment and generates an internal representation 104 of that “experience.” Received sensory inputs 102 become the state values for the cell or node. Internal representation 104 may be considered a form of dynamic memory storage. As shown in FIG. 1, the internal representation 104 may be in the form of an underlying graph, or “lattice.” The internal representation 104 acts on the received sensory inputs 102 to produce outputs 106.

Still referring to FIG. 1, and in greater detail, the model 100 takes sensory inputs 102 from the environment. Inputs 102 may represent sensor inputs experienced from the environment. For example, in autonomous controls applications, inputs 102 may be data inputs from sensors such as location sensors, vision data from cameras, or haptic information from pressure sensors. In a simulated environment, inputs 102 may be extracts from a data file or feed. In other embodiments, inputs 102 may include values from the internal representation 104 when, for example, the model is allowed to recurse in order to arrive at a final output state.

Inputs 102 may be processed by the current state of the internal representation 104. In one embodiment, whenever two inputs 102 appear at substantially the same time, they are considered coincident and connected in the internal representation 104. In other embodiments, inputs 102 may have to substantially simultaneously exceed a predetermined threshold (or fall below a predetermined threshold) in order to be connected.

Each input 102 may signal nodes in the internal representation 104 to which it is connected. In some embodiments, the signal sent to connected nodes is attenuated. In certain of these embodiments, the attenuation factor depends on the number of nodes to which the input 102 is connected. In specific ones of these embodiments, the attenuation factor directly corresponds to the number of nodes to which the input is connected, e.g., each signal is divided by the number of nodes to which the input is connected. In other embodiments, node weightings may result in different attenuations factors for different signals.

Each cell generates a new state based on the underlying graph or lattice according to a cell update function Φ. The formula below shows one embodiment of the cell update function for a single input xₙ: the output for that same node includes of the original input signal (set at 1, to start, in some embodiments) and the sum of the values of the connected nodes times the attenuation value aₙₙ.

$$ϕ ( {x}_{n} ) = {x}_{n} + {a}_{nn} {\sum }_{n = 1}^{m} {c}_{in} {x}_{i}$$

Generalizing this embodiment to any number of inputs, the main function can be simplified to the form shown below.

ϕ(x)=x(A∘C+I)

One interpretation of the formula above is that the input vector x (sensor inputs 102) is “acted” on by the attenuated connection matrix C. The identity matrix, I, expresses the original input vector value (taking the place of the xₙ value from the prior equation). Stated differently, a set of nodes are activated by the environment and they, in turn, activate all the nodes to which they are connected, resulting in a new “state” of all the nodes in the network. In these embodiments, the attenuated connection matrix, C, changes dynamically, that is, the connections between the nodes represented by the attenuated connection matrix, C, is generated by experience and is specified by the last update function.

In some embodiments, the update function Φ may recurse a set number of times, where the main function generates an output state ϕ(x), which is then fed back into the same function again, r times. This is expressed in the simple recursion function below:

ω(xₙ)=ϕ^{r}(xₙ)+lϕ^{r}(xₙ₋₁)

For example, if input signals A and B are linked and input signals B and C are linked, a recursion range of 2 will generate a signal at C, even if only A is fired.

The second term includes latency, l, from the last term. Latency can be thought of as the amount of “leftover” output that is re-cycled into the next input set. In these embodiments, latent inputs may allow the result of the cell update function to continue changing, even if all inputs are shut off.

In some embodiments, the internal representation 104 can also be updated based on the new inputs according to an update function ψ. In some of these embodiments, the update function ψ uses the inputs that the system has just “experienced” and updates the values of each of the connections between the nodes in the matrix according to the following equation:

$$ψ ( {C}_{ij} ) = \{ \begin{matrix}{x}_{i} {x}_{j} & if {C}_{ij} = 0 and i \neq j \\ {dC}_{ij} & if {C}_{ij} > b and i \neq j and {x}_{i} {x}_{j} \neq 0 \\ {C}_{ij} & otherwise\end{matrix}$$

The equation above represents the following three occurrences:

If two inputs are seen together for the first time, the connection is set to one input times the other.

If two inputs are seen together for a second time, the current connection value is decreased by a factor d (the “de-inforcement factor”). In some embodiments, d may be the reciprocal of the number of times the two inputs have appeared together. In some of these embodiments, the “de-inforcement” factor will have a “floor” value, b. In still other embodiments, “de-inforcement” may be subject to “re-inforcement” over time if the two signal inputs have not been seen together for a predetermined number of cycles. This has the effect of encouraging the model to explore the representation of the environment, as coincident inputs that have been seen before are discounted.

If no simultaneous inputs are detected at that time window, nothing is changed.

The final state of the cell values may be used by the model as the basis for choice or action which can then influence the environment.

The connection state of the system may be expressed as a weighted adjacency matrix having initial weights of 1. Thus, for an embodiment in which input signals A and B are coincident and input signals B and C are coincident, with a recursion level set to 2 and latency value set to zero, the functioning of the model may be represented as follows:

$$\begin{matrix}\begin{matrix}Input & & & & Attenuation & & Matrix C & & Identity i & & Output\end{matrix} \\ [ \begin{matrix}1 & 0 & 0\end{matrix} ] \times ( [ \begin{matrix}1 & 1 & 1 \\ \text{.5} & \text{.5} & \text{.5} \\ 1 & 1 & 1\end{matrix} ] ⊙ [ \begin{matrix}0 & 1 & 0 \\ 1 & 0 & 1 \\ 0 & 1 & 0\end{matrix} ] + [ \begin{matrix}1 & 0 & 0 \\ 0 & 1 & 0 \\ 0 & 0 & 1\end{matrix} ] ) = [ \begin{matrix}1 & 1 & 0\end{matrix} ] \\ [ \begin{matrix}1 & 1 & 0\end{matrix} ] \times ( [ \begin{matrix}1 & 1 & 1 \\ \text{.5} & \text{.5} & \text{.5} \\ 1 & 1 & 1\end{matrix} ] ⊙ [ \begin{matrix}0 & 1 & 0 \\ 1 & 0 & 1 \\ 0 & 1 & 0\end{matrix} ] + [ \begin{matrix}1 & 0 & 0 \\ 0 & 1 & 0 \\ 0 & 0 & 1\end{matrix} ] ) = [ \begin{matrix}1.5 & 2 & \text{.5}\end{matrix} ]\end{matrix}$$

Note that Output y from the first pass is used as the input x for the second pass. Attenuation matrix A divides the input signal by the number of connections, thus, the attenuation row for B is 0.5, because it is connected to both A and C. It should be understood that, although only two passes are described in this document, any number of recursions may be used in operation of the system.

All inputs and outputs are discarded after they've been processed. If output y is considered to be the model's “experience” at a particular moment in time, “memory” may be defined as the difference between that experience and the actual sensory input at that moment.

One embodiment of code for the early test implementations of the method is attached in the Appendix. Although one of ordinary skill in the art should be able to read the attached code to determine its function, a brief summary of its function is provided below:

Line 5: Main matrix function runmatrix is defined. Each input scans across the matrix, and if it sees it is “connected” to another input label, then it will “fire” that circuit, multiplied by matrix value of that specific connection, but reduced by the afactor “attenuation” rate. After all the inputs have been scanned and fired, the resulting outputs are returned as register at Line 31.

Lines 35-37: Reinforcement, Attenuation and Latency Factors are set up.

Lines 39-52: Inputs are imported from csv files. In other embodiments, inputs may be imported from physical sources, such as sensors.

Lines 69-112: Execution of the “waterfall” iteration. As shown in the attached code, there are 4 “layers” in the waterfall—the original input signal, plus 3 iterations of attenuated signals. Any number of waterfall iterations may be provided, however.

Lines 124-134: The outputs are normalized to fall between 1 and 0.

Lines 136-165: The core matrix is updated to reflect any new coincidents in the new input list.

Lines 167-185: Writing various outputs to csv files. In other embodiments, the various outputs may also be used to control physical devices, such as servo motors for positioning machine elements.

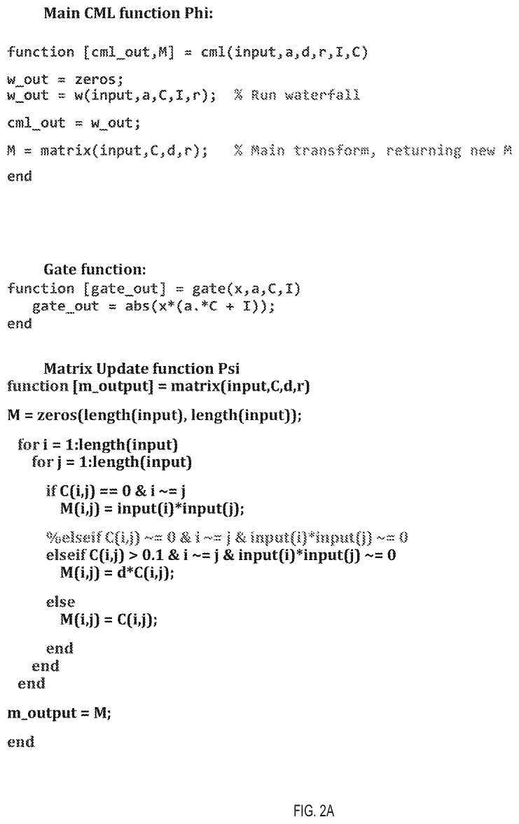

FIGS. 2A and 2B depicts another example of code that may be used to implement an embodiment of the method. FIG. 2A depicts an embodiment of code to implement the update function Φ and the matrix update function ψ. FIG. 2B depicts an embodiment of code to implement the recursion and attenuation functions.

### EXPERIMENTAL RESULTS

As described above, the intent is that a minimal set of information about coincident inputs or stimuli, used iteratively on each input cycle, can generate an output set biasing the system towards one edge or another in a choice graph that includes a reward/penalty function built into the model as an intrinsic characteristic.

In order to compare the efficiency/performance of the described method vs. other approaches, a Reinforcement Learning (RL)-like environment is simulated, analogous to “gridworld” problems common in RL models. Although the overall problem being solved is analogous to RL methods, the actual methods are quite different.

Similar to RL, an environment was setup in which an agent moved and used training sessions to discover a target (reward) location. The effectiveness of the agent, after training, was evaluated by placing the agent back in the environment to find its way to the target again. As the described methods are different, there were certain differences to how the gridworld environment was specified.

The abstraction used in the described technology lies in navigating a stimulus/action environment, which can be represented as a “graph” much as might be used in network theory. As shown below, the left-hand image shows a typical “gridworld,” a 4×4 grid, with a start location (1) and a target location (16). Typically, an RL agent would have four directions it could choose for actions (N-E-S-W), and then some values for reward in the target location. This is not the case in the described technology, as shown in the right-hand image below. The right-hand image shows an undirected graph type representation for a similar setup. The choices are represented by the edges, so for instance, there is no “North” action available to any of the locations/nodes on the top row. Although the graph representation may be considered the “coordinate system” in which the agent navigating, in the case of the described technology, the action choices within the graph description are included in each link.

Another of the key elements of the described approach is that the stimulus choice dynamic is entirely encapsulated within the same method—i.e., there is no separately specified “executive” function, or actor-critic feedback mechanism, etc. In other words, the action is determined directly by the strength of the output signal only. It is mechanistic and could be as easily described as “compulsion” as “choice”.

Running the Experiments

The experiments tested the ability of the agent, after various training runs or “paths” through the environment, to be able to find its way to the target node. The various settings of the parameters (Reinforcement, Attenuation, Latency, or RAL) are also observed to see how they affect the behavior of the agent. The procedure is as follows:
1. Generate an array of inputs that match a “path” specified by the investigator.
2. Place that input array into the Training module.
3. Specify the RAL parameters for the Training routine.
4. Specify the number of “waterfall” layers, or iterations.
5. Zero the model with the exception of setting up the reward entry.
6. Zero the latency buffer.
7. Run the Training module.
8. Copy the resultant model into the Auto module.
9. Copy the resultant latency buffer (list) into the Auto module
10. Copy the appropriate coordinate system into the Auto module
11. Set a start node as a single input into the Auto module.
12. Run the Auto module and see the resultant path generated.

Experiment #1:

[reinforcement=0.2, attenuation=0.5, latency=0.1, waterfall layers=4]

Reward=3 at node (16)

Short partial run: Continuous training run, partial grid. Nate that the training path in red has a “start” node (“s”) and an “end” node (“e”). In the automated agent run in green, there is a start node “s”: and a “target” node “t” which is specified in the Coincident Matrix.

Reward and Penalty Navigation in Lattice Graphs

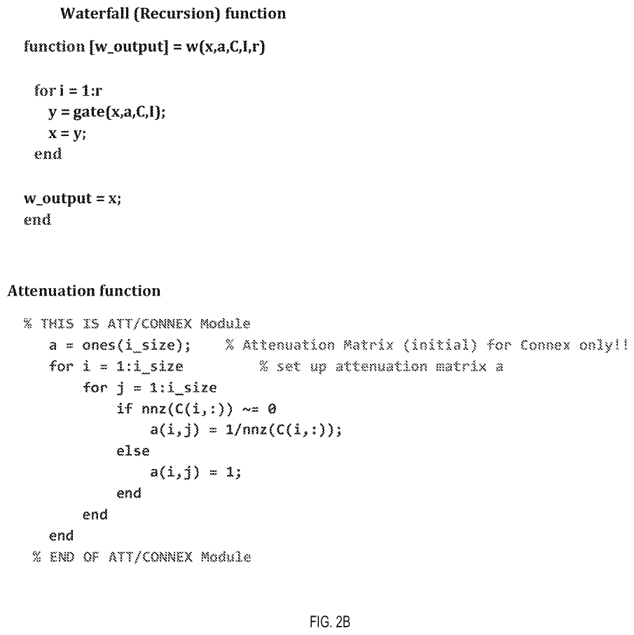

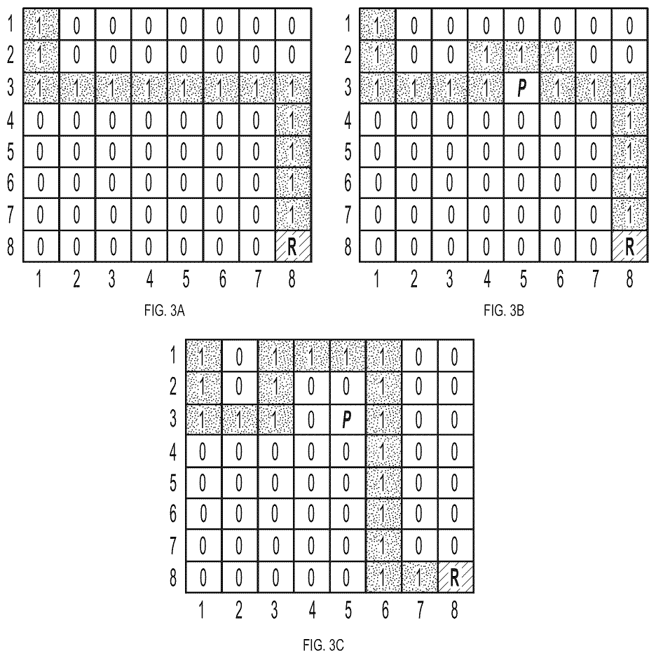

Testing the model in an 8×8, 64-node lattice graph approximating a reinforcement learning gridworld task showed that the agent could successfully navigate to the reward-connected node after a single training run exposing the agent to all the nodes (excluding the reward or penalty circuits). Note that in this series of experiments, the reward and penalty circuits are separate circuits. By placing the penalty node in the middle of the path preferred by the agent when the penalty was absent, it was observed that it adjusted as penalties were increased. With reference to FIG. 3A, shown is an agent's behavior with a reward valued at 3 located at cell (8,8), which is a direct path to the reward. FIG. 3B depicts the agent's behavior with a reward valued at 3 located at cell (8,8) and a penalty value of −3 at cell (3,5). As can be seen, the agent avoids cell (3,5) while traversing towards the reward. FIG. 3C shows an agent's behavior with a reward valued at 3 located at cell (8,8) and a penalty value of −5 at cell (3,5). As can be seen, the agent avoids cell (3,5) by a larger margin, due to the increased penalty, while traversing towards the reward.

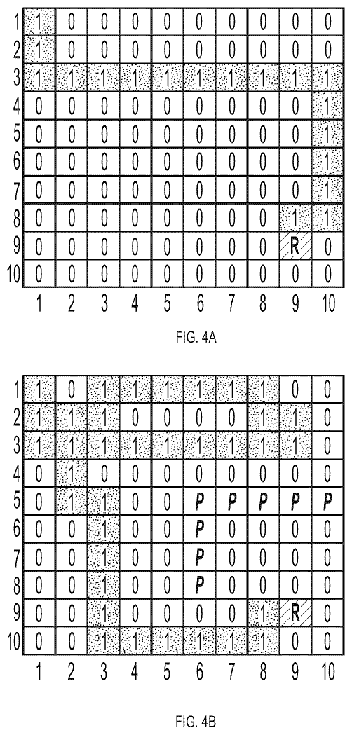

The behavior of the agent when trained in a more complex penalty environment was observed. In this experiment, a larger, 10×10, 100-node lattice graph with a penalty barrier partially surrounding the reward node was used, as can be seen in FIGS. 4A-4B. FIG. 4A shows the path taken by the agent to the reward cell (9,9) with no barrier in place. FIG. 4B shows the path taken by the agent when the partial barrier is put in place, from cell (5,5) to (5, 10) and (5,5) to (8,5). As can be seen in FIG. 4B the agent begins along the same path as traversed with no barrier in place, changes direction, and doubles back to find a successful route.

Observing the Signal Gradient in Two Dimensions

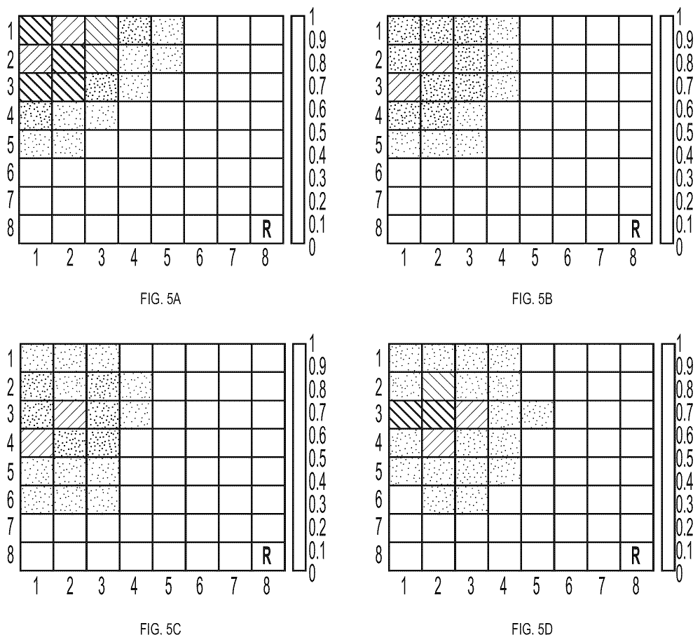

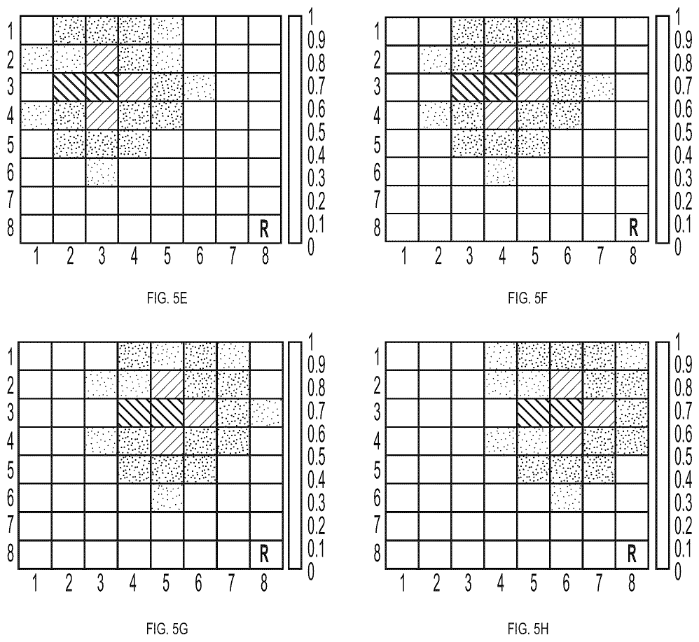

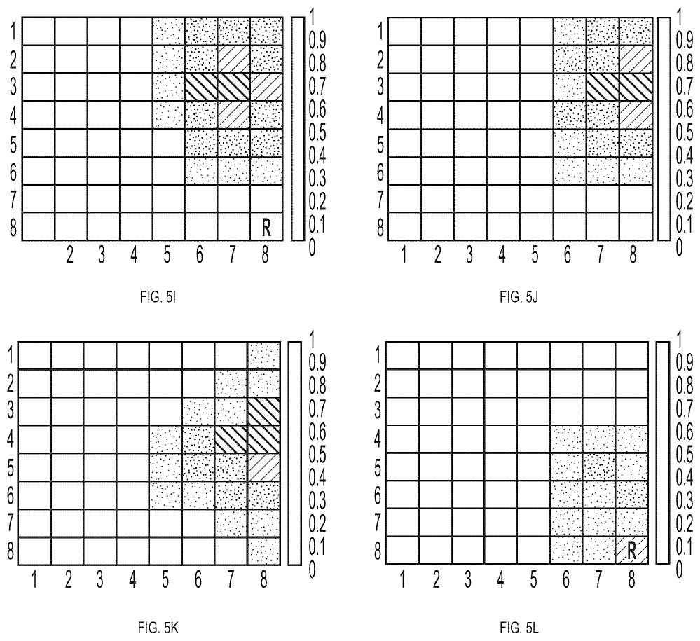

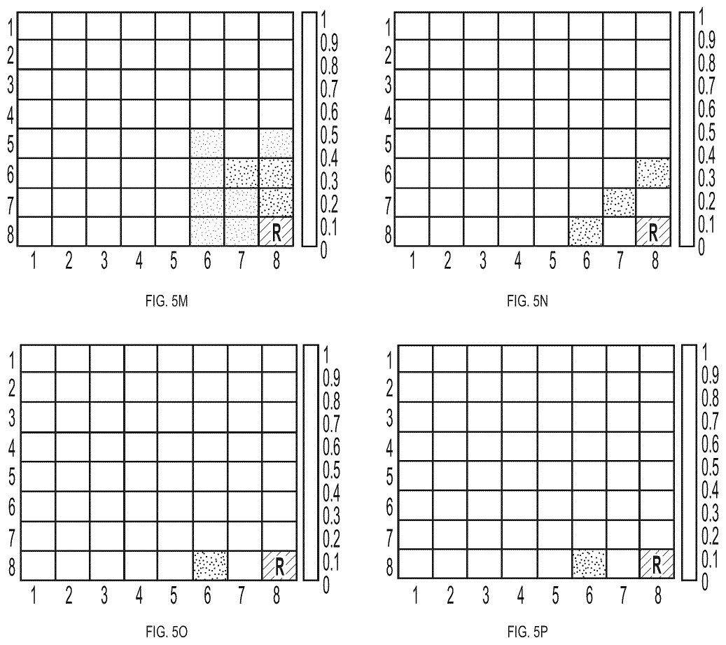

In order to understand the behavior of the signal gradient in the lattice-like environment tested in the experiments above, a heatmap of the node values at each step generated by agent during a run can be observed, as shown in FIGS. 5A-5P. FIGS. 5A-5P depict an embodiment in which the agent starts at cell (1,1) and traverses towards a reward at cell (8,8) with no penalty values. It is expected that the mechanism will be the same in non-grid-like graphs, although it is easier to visualize the underlying dynamic in a Cartesian type of setting.

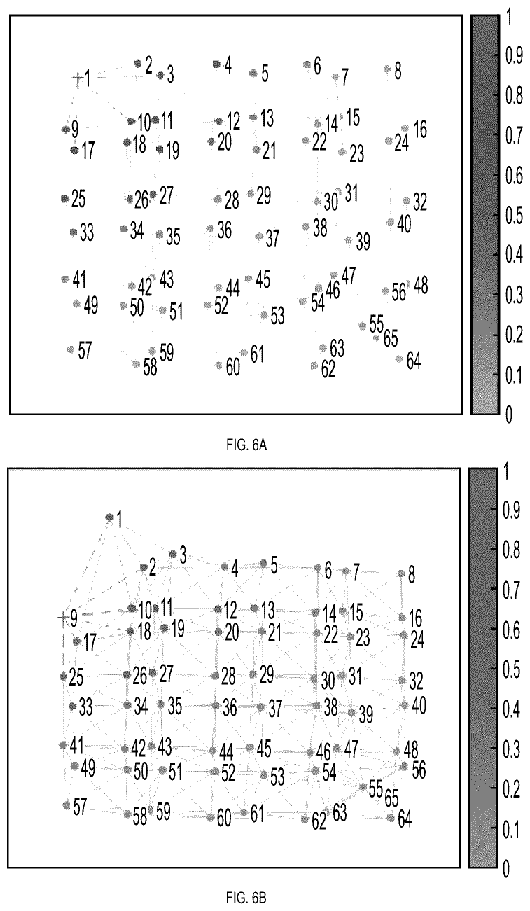

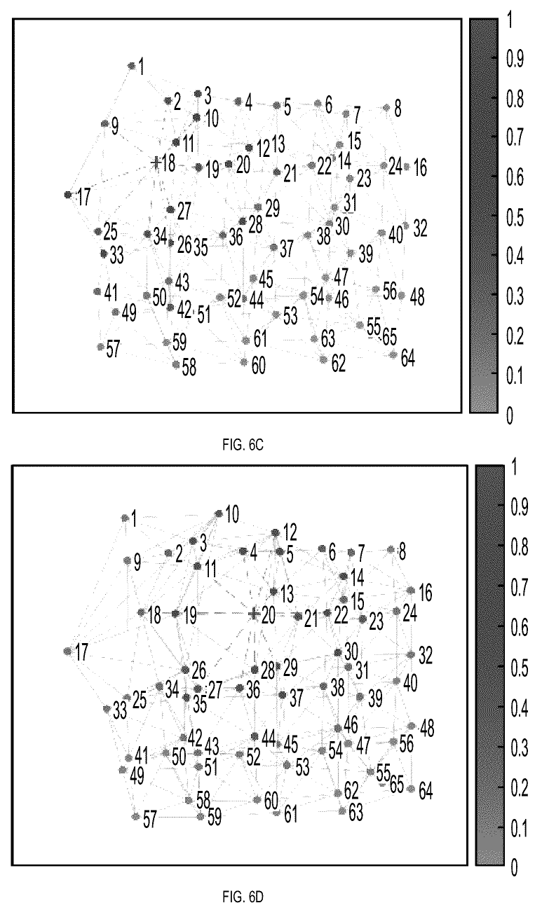

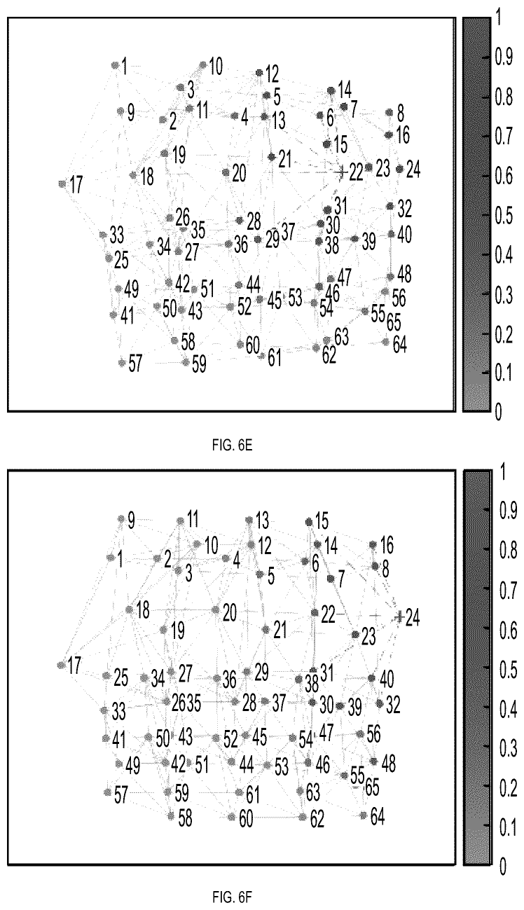

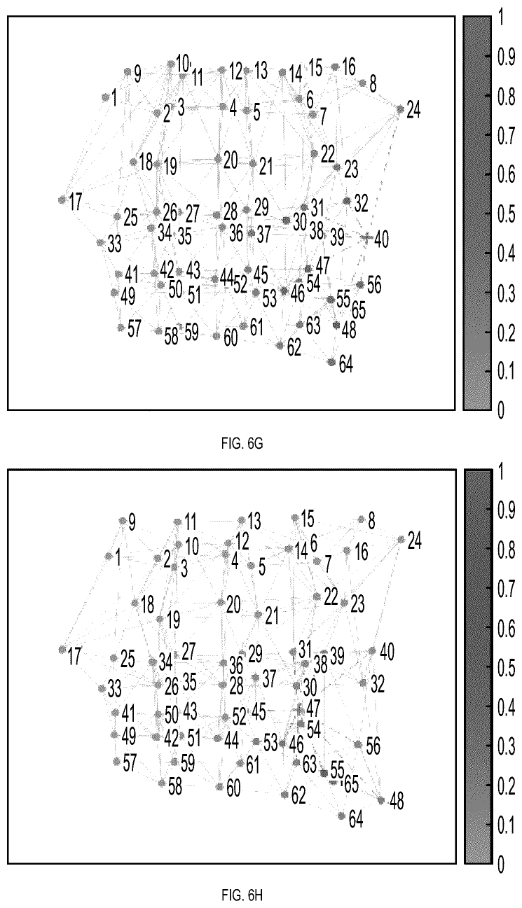

In order to gain insight into both the resultant node signal gradient as well as the underlying plasticity (or weighting) of the coincident matrix as a consequence of de-inforcement, a plot may be created of both the node values as well as the graph edges of selected steps during an agent's run. FIGS. 6A-6H depict such graphs for selected steps during which the agent starts at cell (1,1) and traverses towards a reward at cell (8,8) with no penalty values. Higher attenuation of edges is shown as longer edge lengths. It may be observed that the plasticity changes on every step and remains so in the “neighborhood” of the visited nodes.

Randomized Trials

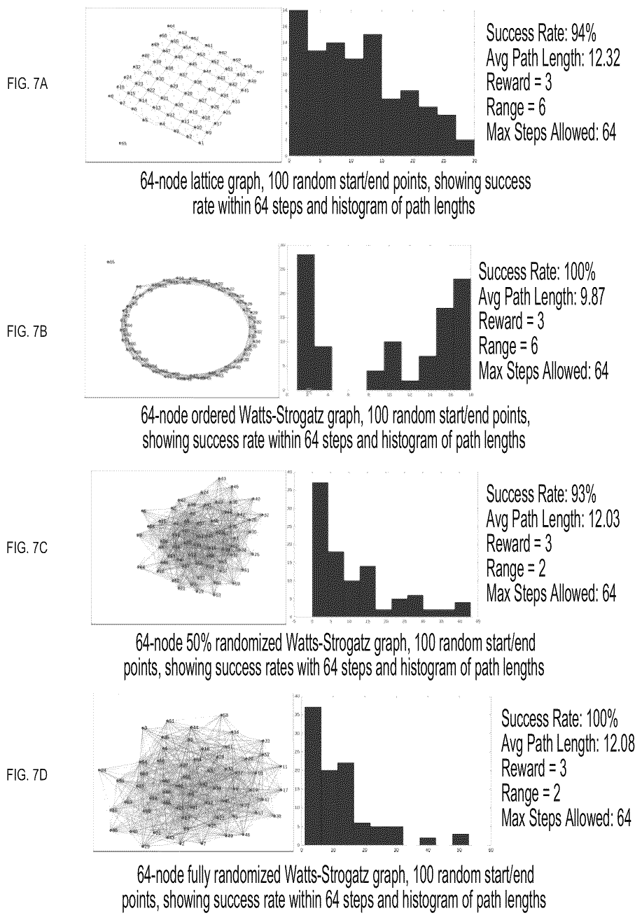

In a set of randomized trials, a broader range of graphs were tested, including ordered ring lattices and randomized Watts-Strogatz networks. Each of 100 trials used a single training run over a 64-node graph in which random pairs of start/target nodes were tested. The agent was allowed a maximum of 64 total steps to find and stay on the target node for a minimum of three steps. As shown in FIG. 7A-7D, the described method performed well, with success rates in the range of 93% to 100% for four different trials. The average number of steps to target ranged from 9.87 to 12.32. The only parameter that was changed between trials was the range r, as indicated in the FIGS. 7A-7D.

The methods and systems described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, LISP, PERL, C, C++, PROLOG, or any byte code language such as JAVA. The software programs may be stored on or in one or more articles of manufacture as object code.

Having described certain embodiments of the technology, it will now become apparent to one of skill in the art that other embodiments incorporating the concepts of the invention may be used. Therefore, the invention should not be limited to certain embodiments, but rather should be limited only by the spirit and scope of the following claims.

What is claimed:

1. A method comprising the steps of:
(a) obtaining a plurality of environmental inputs;
(b) combining the obtained plurality of environmental inputs with a model and an attenuation factor to produce a plurality of intermediate outputs; and
(c) combining the plurality of intermediate outputs with the model and the attenuation factor to produce a plurality of final outputs.

2. The method of claim 1, wherein step (a) comprises obtaining the plurality of environmental inputs from an output of a model.

3. The method of claim 1, wherein step (a) comprises obtaining the plurality of inputs from a sensing device.

4. The method of claim 1, wherein step (b) comprises combining the obtained plurality of environmental inputs with a model matrix and a matrix of attenuation factors to produce a plurality of intermediate outputs.

5. The method of claim 1, wherein step (b) comprises combining the obtained plurality of environmental inputs with a model matrix, a matrix of attenuation factors and the identity matrix to produce a plurality of intermediate outputs.

6. The method of claim 1, comprising repeating step (c) a predetermined number of times to produce a plurality of final outputs.

7. The method of claim 1, further comprising the step of updating the model based on the obtained inputs.

8. The method of claim 7, comprising applying a de-inforcement factor to the model.

9. A Machine Learning system comprising:
(a) an input register storing a plurality of obtained environmental inputs;
(b) a model storing associations between ones of the plurality of obtained environmental inputs;
(c) an attenuator combining attenuation values with the model to produce an attenuated model; and
(d) a combiner producing a plurality of output values based the attenuated model and the plurality of obtained inputs.

10. The system of claim 9, further comprising a plurality of sensors obtaining environmental inputs.

11. The system of claim 9, further comprising soring the plurality of output values in the input register.

12. The system of claim 9, wherein the model comprises a matrix

13. The system of claim 10 wherein the attenuation values comprise a matrix.

14. The system of claim 13, wherein the combiner produces a plurality of output values based on the plurality of environmental inputs, the model matrix, the matrix of attenuation factors and the identity matrix.

15. The system of claim 9, wherein the combiner producing a plurality of final output values based the attenuated model and the plurality of produced output values.

16. The system of claim 9, further comprising a model maintainer updating the model based on the obtained inputs.

17. The system of claim 16, wherein the model maintainer applies a de-inforcement factor to the model.
